(19) United States
(12) Patent Application Publication
(10) Pub. No.: US 2024/0259884 A1
(43) Pub. Date: Aug. 1, 2024

(54) GROUP HANDOVER OF TERMINALS AT HANDOVER OF RELAY

(71) Applicant: Sony Group Corporation, Tokyo (JP)

(72) Inventors: Yuxin WEI, Basingstoke (GB); Vivek SHARMA, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 18/578,738

(22) PCT Filed: Jul. 6, 2022
(86) PCT No.: PCT/EP2022/068786

§ 371 Date: Jan. 12, 2024

(30) Foreign Application Priority Data
Jul. 19, 2021 (EP) 21186510.0

(51) Int. Cl. H04W 36/00; H04W 36/32

(52) U.S. Cl. CPC H04W 36/0009; H04W 36/324

(57) ABSTRACT

A wireless telecommunications method comprising: determining if a terminal configured to communicate with a serving node via a relay has characteristics indicating the terminal should be handed over from a source serving node to a first target serving node if the relay is handed over from the source serving node to the first target serving node; if the terminal has the characteristics, controlling the terminal to be handed over from the source serving node to the first target serving node if the relay is handed over from the source serving node to the first target serving node; and if the terminal does not have the characteristics, controlling the terminal to be handed over from the source serving node to a second, different, target serving node if the relay is handed over from the source serving node to the first target serving node.

### BACKGROUND

### Field of the Disclosure

The present disclosure relates to a wireless telecommunications system and method.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

Recent generation mobile telecommunication systems, such as those based on the 3^{rd} Generation Partnership Project (3GPP (RTM)) defined Universal Mobile Telecommunications System (UMTS), Long Term Evolution (LTE) and 5G New Radio (NR) architectures, are able to support a wider range of services than simple voice and messaging services offered by previous generations of mobile telecommunication systems. For example, with the improved radio interface and enhanced data rates provided by LTE and NR systems, a user is able to enjoy high data rate applications such as mobile video streaming and mobile video conferencing that would previously only have been available via a fixed line data connection. In addition to supporting these kinds of more sophisticated services and devices, it is also proposed for newer generation mobile telecommunication systems such as NR to support less complex services and devices which make use of the reliable and wide ranging coverage of newer generation mobile telecommunication systems without necessarily needing to rely on the high data rates available in such systems.

The demand to deploy such networks is therefore strong and the coverage area of these networks, i.e. geographic locations where access to the networks is possible, may be expected to increase ever more rapidly. There is also a continuing need to improve the network speed, reliability, efficiency and/or flexibility of these networks.

### SUMMARY

The present disclosure is defined by the claims.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 schematically represents some elements of a LTE-type wireless telecommunications system which may be configured to operate in accordance with embodiments;

FIG. 2 schematically represents some elements of a NR-type wireless telecommunications system which may be configured to operate in accordance with embodiments;

FIG. 3 schematically represents some components of the wireless telecommunications system shown in FIG. 2 in more detail which may be configured to operate in accordance with embodiments;

FIG. 4 schematically represents some elements of a NR-type wireless telecommunications system which may be configured to operate in accordance with embodiments;

FIG. 5 schematically represents a group handover scenario to which embodiments may be applied;

FIG. 6 schematically represents a first example of managing group handover according to embodiments;

FIG. 7 schematically represents a second example of managing group handover according to embodiments;

FIG. 8 schematically represents a third example of managing group handover according to embodiments;

FIG. 9 schematically represents a fourth example of managing group handover according to embodiments; and

FIG. 10 shows an example method according to embodiments.

Like reference numerals designate identical or corresponding parts throughout the drawings.

### DETAILED DESCRIPTION OF THE EMBODIMENTS

### Long Term Evolution (LTE) Wireless Communications System

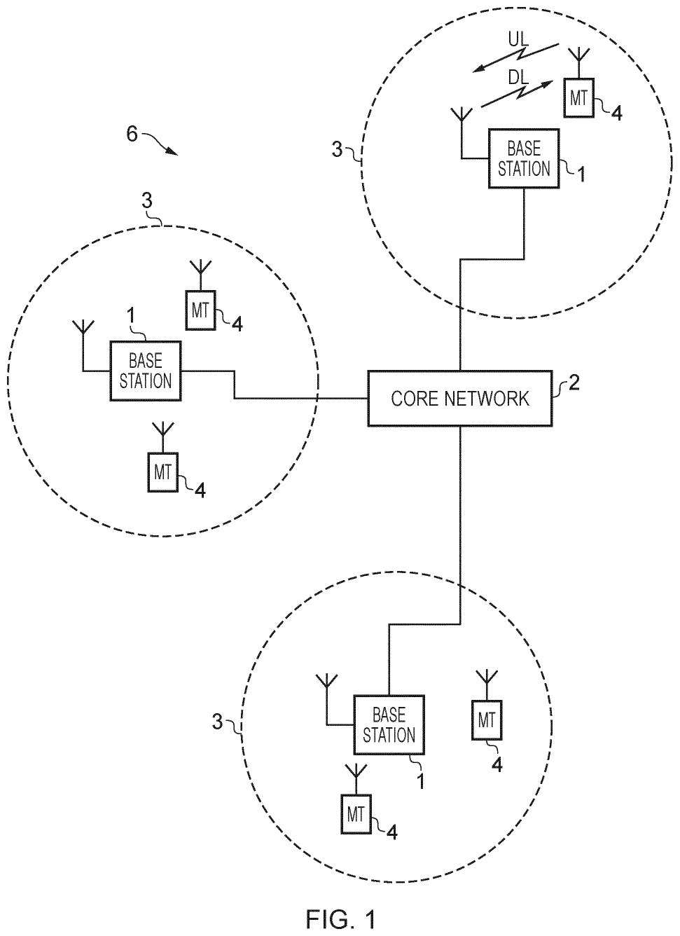

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4.

Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. A communications device may also be referred to as a mobile station, user equipment (UE), user terminal, mobile radio, terminal device and so forth.

Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

A base station which is an example of network infrastructure equipment, may also be referred to as a transceiver station, nodeB, e-nodeB, eNB, g-nodeB, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### 5G New Radio (NR) Wireless Communications System

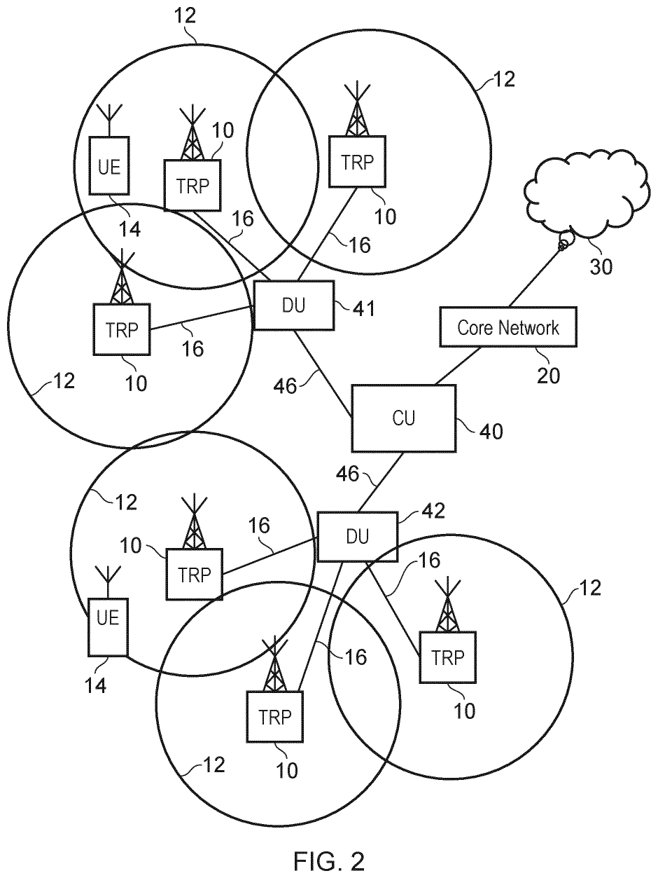

An example configuration of a wireless communications network which uses some of the terminology proposed for NR is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to a core network 20 which may contain all other functions required for communicating data to and from the wireless communications devices and the core network 20. The core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2 and of other networks discussed herein in accordance with embodiments of the disclosure which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated, therefore, that operational aspects of an NR network (for example in relation to specific communication protocols and physical channels for communicating between different elements) may be different to those known from LTE or other known mobile telecommunications standards. However, it will also be appreciated that each of the core network component, base stations and communications devices of an NR network will be functionally similar to, respectively, the core network component, base stations and communications devices of an LTE wireless communications network.

In terms of broad top-level functionality, the core network 20 connected to the NR telecommunications system represented in FIG. 2 may be broadly considered to correspond with the core network 2 represented in FIG. 1, and the central unit 40 and associated DUs 41, 42/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the CU 40, DUs 41, 42 and/or TRPs 10. Communications devices 14 are represented in FIG. 2 within the coverage area of respective communication cells 12. These communications devices 14 may thus exchange signalling with the CU 40 via the TRP 10 associated with their respective communications cells 12.

It will further be appreciated that FIG. 2 represents merely one example of a proposed architecture for an NR-based telecommunications system in which approaches in accordance with the principles described herein may be adopted, and the functionality disclosed herein may also be applied in respect of wireless telecommunications systems having different architectures.

Thus certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a CU 40, DU 41, 42 and/or TRP 10 of the kind shown in FIG. 2 which is adapted to provide functionality in accordance with the principles described.

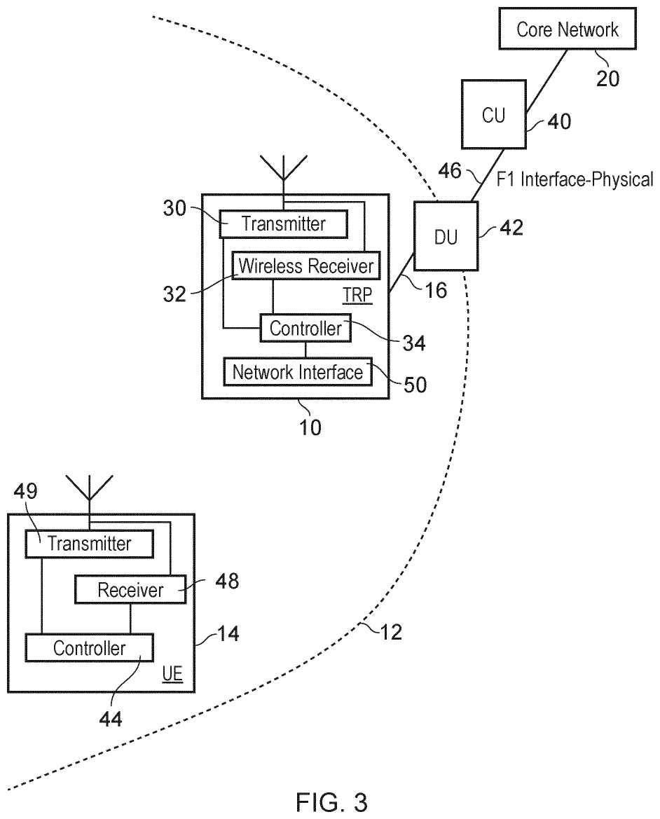

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which is configured to control the transmitter 30 and the receiver 32 to transmit radio signals to and receive radio signals from one or more UEs 14 within a cell 12 formed by the TRP 10. As shown in FIG. 3, an example UE 14 is shown to include a corresponding wireless transmitter 49, wireless receiver 48 and a controller or controlling processor 44 which is configured to control the transmitter 49 to transmit signals representing uplink data to the wireless communications network via the wireless access interface formed by the TRP 10 and the receiver 48 to receive downlink data as signals transmitted by the transmitter 30 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance, for example, with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473 and, for example, may be formed from a fibre optic or other wired high bandwidth connection. In one example, the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

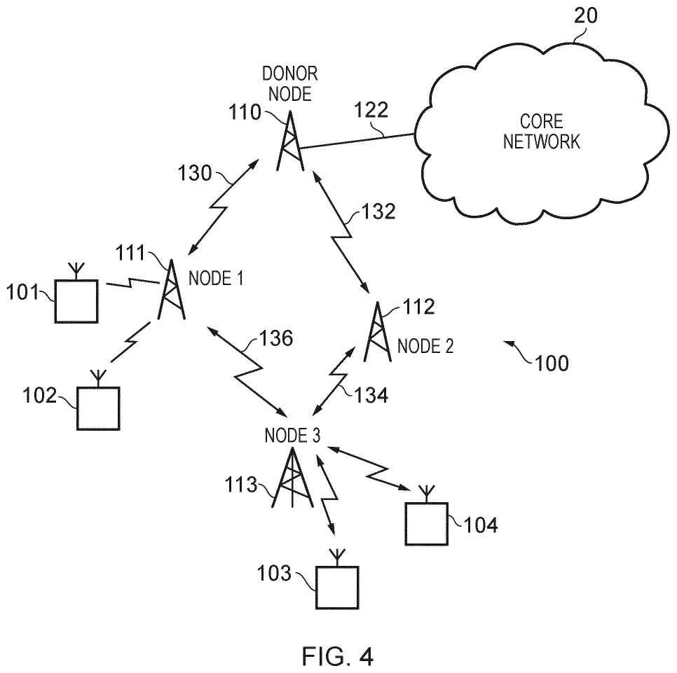

Example arrangements of the present technique can be formed from a wireless communications network corresponding to that shown in FIG. 1 or 2, as shown in FIG. 4. FIG. 4 provides an example in which cells of a wireless communications network are formed from infrastructure equipment which are provided with an Integrated Access and Backhaul (IAB) capability. The wireless communications network 100 comprises the core network 20 and a first, a second, a third and a fourth communications device (respectively 101, 102, 103 and 104) which may broadly correspond to the communications devices 4, 14 described above.

The wireless communications network 100 comprises a radio access network, comprising a first infrastructure equipment 110, a second infrastructure equipment 111, a third infrastructure equipment 112, and a fourth infrastructure equipment 113. Each of the infrastructure equipment provides a coverage area (i.e. a cell, not shown in FIG. 4) within which data can be communicated to and from the communications devices 101 to 104. For example, the fourth infrastructure equipment 113 provides a cell in which the third and fourth communications devices 103 and 104 may obtain service. Data is transmitted from the fourth infrastructure equipment 113 to the fourth communications device 104 within its respective coverage area (not shown) via a radio downlink. Data is transmitted from the fourth communications device 104 to the fourth infrastructure equipment 113 via a radio uplink.

The infrastructure equipment 110 to 113 in FIG. 4 may correspond broadly to the TRPs 10 of FIG. 2 and FIG. 3.

The first infrastructure equipment 110 in FIG. 4 is connected to the core network 20 by means of one or a series of physical connections. The first infrastructure equipment 110 may comprise a TRP 10 having the physical connection 16 to the DU 42 in combination with the DU 42 having the physical connection to the CU 40 by means of the F1 interface 46. The CU 40, in turn, is connected by means of a physical connection (e.g. fibre optic) to the core network 20.

However, there is no direct physical connection between any of the second infrastructure equipment 111, the third infrastructure equipment 112, and the fourth infrastructure equipment 113 and the core network 20. As such, it may be necessary or otherwise determined to be appropriate for data received from a communications device (i.e. uplink data) or data for transmission to a communications device (i.e. downlink data) to be transmitted to or from the core network 20 via other infrastructure equipment, such as the first infrastructure equipment 110, which has a physical connection to the core network 20, even if the communications device is not currently served by the first infrastructure equipment 110 but is, for example, in the case of the wireless communications device 104, served by the fourth infrastructure equipment 113.

The second, third and fourth infrastructure equipment 111 to 113 in FIG. 4 may each comprise a TRP, broadly similar in functionality to the TRPs 10 of FIG. 2.

In some arrangements of the present technique, one or more of the second to fourth infrastructure equipment 111 to 113 in FIG. 4 may further comprise a DU 42, and in some arrangements of the present technique, one or more of the second to fourth infrastructure equipment 110 to 113 may comprise a DU and a CU.

In some arrangements of the present technique, the CU 40 associated with the first infrastructure equipment 110 may perform the function of a CU not only in respect of the first infrastructure equipment 110, but also in respect of one or more of the second, the third and the fourth infrastructure equipment 111 to 113.

In order to provide the transmission of the uplink data or the downlink data between a communications device and the core network, a route is determined by any suitable means, with one end of the route being an infrastructure equipment physically connected to a core network and by which uplink and downlink traffic is routed to or from the core network.

In the following, the term ‘node’ is used to refer to an entity or infrastructure equipment which forms a part of a route for the transmission of the uplink data or the downlink data.

An infrastructure equipment, which is physically connected to the core network and operated in accordance with an example arrangement may provide communications resources to other infrastructure equipment and so is referred to as a ‘donor node’. An infrastructure equipment which acts as an intermediate node (i.e. one which forms a part of the route but is not acting as a donor node) is referred to as a ‘relay node’. It should be noted that although such intermediate node infrastructure equipment acts as relay nodes on the backhaul link, they may also provide service to communications devices. The relay node at the end of the route which is the infrastructure equipment controlling the cell in which the communications device is obtaining service is referred to as an ‘end node’.

Hence, for clarity and conciseness in the following description, the first infrastructure equipment 110 is referred to below as the ‘donor node’, the second infrastructure equipment 111 is referred to below as ‘Node 1’, the third infrastructure equipment 112 is referred to below as ‘Node 2’ and the fourth infrastructure equipment 113 is referred to below as ‘Node 3’.

For the purposes of the present disclosure, the term ‘upstream node’ is used to refer to a node acting as a relay node or a donor node in a route which is a next hop when used for the transmission of data via that route from a wireless communications device to a core network. That is, ‘upstream node’ is used to refer to a relay node or a donor node to which uplink data is transmitted for transmission to a core network. Similarly, ‘downstream node’ is used to refer to a relay node from which uplink data is received for transmission to a core network. For example, if uplink data is transmitted via a route comprising (in order) the Node 3 113, the Node 1 111 and the donor node 110, then the donor node 110 is an upstream node with respect to the Node 1 111, and the Node 3 113 is a downstream node with respect to the Node 1 111.

More than one route may be used for the transmission of the uplink/downlink data from/to a given communications device. This is referred to as ‘multi-connectivity’. For example, the uplink data transmitted by the wireless communications device 104 may be transmitted either via the Node 3 113 and the Node 2 112 to the donor node 110, or via the Node 3 113 and the Node 1 111 to the donor node 110.

The donor node 110 and the second to fourth infrastructure equipment acting as the Nodes 1 to 3 111, 112, 113 may communicate with one or more other nodes by means of one or more inter-node wireless communications links (which may also be referred to “wireless backhaul communications links”). For example, FIG. 4 illustrates four inter-node wireless communications links 130, 132, 134, 136.

Each of the inter-node wireless communications links 130, 132, 134, 136 may be provided by means of a respective wireless access interface. Alternatively, two or more of the inter-node wireless communications links 130, 132, 134, 136 may be provided by means of a common wireless access interface and, in particular, in some arrangements of the present technique, all of the inter-node wireless communications links 130, 132, 134, 136 are provided by a shared wireless access interface.

A wireless access interface, which provides an inter-node wireless communications link, may also be used for communications between an infrastructure equipment and a communications device which is served by the infrastructure equipment. For example, the fourth wireless communications device 104 may communicate with the Node 3 113 using the wireless access interface which provides the inter-node wireless communications link 134 connecting the Node 3 113 and the Node 2 112.

The wireless access interface(s) providing the inter-node wireless communications links 130, 132, 134, 136 may operate according to any appropriate specifications and techniques.

Examples of wireless access interface standards include the 3GPP-specified General Packet Radio Service (GPRS)/Enhanced Data rates for Global Evolution (EDGE) (“2G”), Wideband Code-Division Multiple Access (WCDMA)/Universal Mobile Telecommunications System (UMTS) and related standards such as High Speed Packet Access (HSPA) and HSPA+(“3G”), LTE and related standards including LTE-Advanced (LTE-A) (“4G”), and NR (“5G”). Techniques that may be used to provide a wireless access interface include one or more of time-division multiple access (TDMA), frequency-division multiple access (FDMA), orthogonal frequency-division multiple access (OFDMA), single-carrier frequency-division multiple access (SC-FDMA), code-division multiple access (CDMA). Duplexing (i.e. the transmission over a wireless link in two directions) may be by means of frequency division duplexing (FDD) or time division duplexing (TDD) or a combination of both.

In some arrangements of the present technique, two or more of the inter-node wireless communications links 130, 132, 134, 136 may share communications resources. This may be because two or more of the inter-node wireless communications links 130, 132, 134, 136 are provided by means of a single wireless access interface or because two or more of the inter-node wireless communications links 130, 132, 134, 136 nevertheless operate simultaneously using a common range of frequencies.

The nature of the inter-node wireless communications links 130, 132, 134, 136 may depend on the architecture by which the wireless backhaul functionality is achieved.

If a relay node is mobile (i.e. movable, e.g. attached to a moving vehicle), it may need to perform a handover operation to switch from being served from one upstream node to another upstream node in order to maintain a satisfactory connection to the network and, by extension, for further downstream nodes or terminal devices which connect to the network via the relay node to maintain a satisfactory connection to the network.

To make handover more efficient, group handover can be used. Group handover involves the upstream node serving the relay node (and all downstream devices connected to the relay node) sending a group handover command to the relay node. In response to the group handover command, the relay node, in turn, sends reconfiguration messages to each device it is serving as a relay node to enable handover of these devices with handover of the relay node. The node serving the relay node therefore only has to send one handover command to cover both the relay node and downstream devices served by the relay node rather than having to send a separate handover command to each device. This reduces network overhead. An example of group handover is discussed in [2].

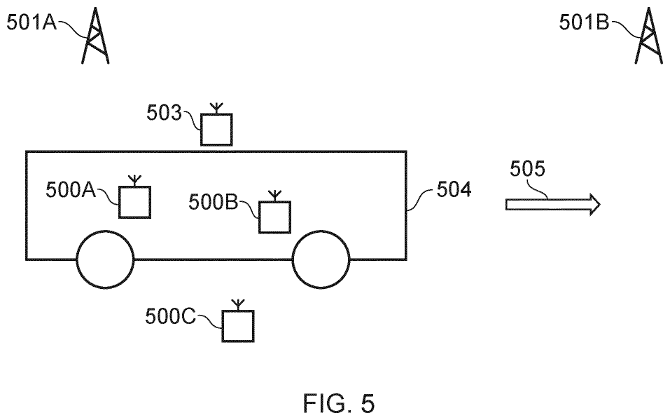

A problem is that, when a relay node is mobile and undergoes a handover from one upstream serving node to another, the relay node may no longer be an appropriate serving node for all the devices currently served by the relay node. It may therefore not be appropriate for all the devices currently served by the relay node to undergo group handover with the relay node. An example of this is given in FIG. 5.

Here, the relay node 503 is a mobile relay node attached to a bus 504. The bus is currently stopped and the relay node 503 is serving three UEs 500A, 500B and 500C. UEs 500A and 500B are located inside the bus (e.g. because they belong to passengers travelling on the bus) whereas UE 500C is located outside the bus (e.g. because it belongs to a person standing on the street near the bus). The relay node 503 is currently served by upstream node 501A. However, as the bus moves in the direction indicated by arrow 505 away from upstream node 501A and towards upstream node 501B, it will be necessary for relay node 503 to be handed over from node 501A to node 501B. If a group handover is used for relay node 503 and the UEs 500A-C, this will maintain satisfactory network connectivity for the relay node and UEs 500A and 500B which travel with the relay node. However, this it is not appropriate for UE 500C, since it will not travel with the relay node 503 and will quickly lose its connection to the network as the bus travels away and the relay node 503 becomes out of range.

There is therefore a need to be able to distinguish between different devices served by the relay node 503 to determine which of those should be included in group handover and which should not (and should, instead, undertake a handover operation to a different, more appropriate new serving node).

In the following examples the relay node 503 is a mobile IAB node and the serving nodes 501A (source serving node) and 501B (target serving node) are fixed IAB nodes. However, the disclosure is not limited to this. More generally, the relay node 503 may be any suitable relay device such as, for example, a relay UE or a relay node of a Non-Terrestrial Network (NTN). Similarly, the serving nodes 501A and 501B may be any suitable infrastructure equipment such as, for example, a base station (e.g. an eNB or gNB) physically connected to the core network via a wired and/or fibre optic connection or a serving NTN node (e.g. a satellite). In this example, the relay node 503 and fixed nodes 501A and 501B have a hardware structure like that of the TRP 10 shown in FIG. 3 and the UEs 500A-C have a hardware structure like that of the UE 14 shown in FIG. 3.

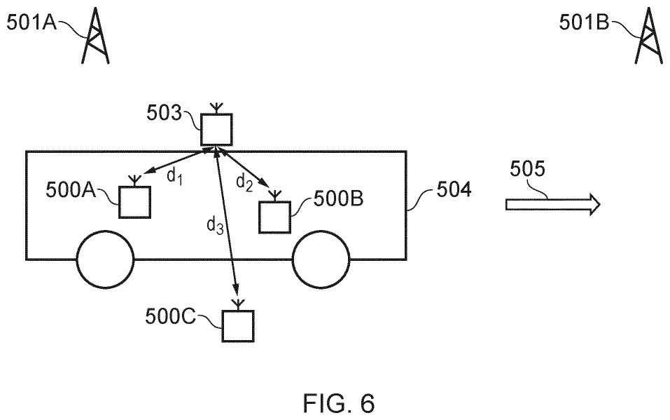

FIGS. 6-9 show some example ways in which the UEs 500A and 500B within the bus (and which should undertake the group handover from node 501A to node 501B with the relay node 503) are distinguishable from the UE 500C outside the bus (which should not undertake the group handover from node 501A to node 501B with the relay node 503). In each case, it is determined (e.g. by the source serving node 501A, relay node 503 and/or the UEs 500A-C) whether each of the UEs 500A-C has a predetermined characteristic indicating it should be handed over from node 501A to node 501B with the relay node 203. If a particular UE has the characteristic, group handover with the relay node 503 is carried out for that UE. This should be the case for UEs 500A and 500B. If a particular UE does not have the characteristic, group handover with the relay node 203 is not carried out and, instead, signalling between that UE and the network is carried out to enable the UE to be served by a different network node than the relay node 503. This should be the case for UE 500C. The signalling between the UE and the network may be carried out via the relay node 503 or via the different network node which is to now serve the UE. In the examples below, as the bus travels from the cell of node 501A to the cell of node 501B, the UE 500C may be handed over to node 501A as its new serving node, for example.

In the example of FIG. 6, the characteristic is that each UE which is to undertake group handover with the relay node 503 is located below a threshold distance from the relay node 503. The relay node 503 and/or each UE 500A-C may determine the distance of each UE from the relay node based on the strength and/or quality of radio signals transmitted between each UE and the relay node (where a predetermined relationship between signal strength and/or quality and distance is determined and stored in advance, with lower signal strength and/or quality generally being associated with greater distance and vice versa) or based on location information (e.g. Global Navigation Satellite System (GNSS) coordinates) determined by each UE and the relay node, for example.

Here, the distance of UE 500A to the relay node 503 is d₁, the distance of UE 500B to the relay node 503 is d₂ and the distance of UE 500C to the relay node 503 is d₃. In an example, the threshold distance dr is set in advanced and may be set, for example, as the maximum distance from the relay node that a UE could be whilst still being within the cabin of the bus 504. For example, the threshold distance could be 10 metres. The threshold distance is set such that d₁ and d₂ are less than the threshold distance and d₃ is greater than the threshold distance. UEs 500A and 500B thus undertake group handover with the relay node 503 from node 501A to node 501B. On the other hand, UE 500B undertakes a separate handover operation from relay node 503 to another network node (e.g. so it is directly served by node 501A).

In a variation of FIG. 6, the distances may be determined with respect to a different node to the relay node 503. For example, the distance between each of the UEs 500A-C and the target serving node 501B may be determined and compared to a threshold distance. In this case, as the bus 504 moves away from the cell of node 501A and towards the cell of node 501B, the distance to the target serving node 501B will decrease for UEs 500A and 500B until it eventually falls below the threshold distance. However, the distance to the target serving node 501B will not decrease in the same way (since UE 500C is not on the moving bus). It can therefore be determined that UES 500A and 500B should undertake group handover with the relay node 503 but not UE 500C.

In a further variation, rather than determining the distance of each UE 500A-C from the relay node 503 or target serving node 501B, the location of each of the UEs with respect to a predetermined geographic area within the cell of the relay node 503 or target serving node 501B may be determined. For example, only those UEs which are within the cell coverage area by a predetermined margin (e.g. inside the cell and more than a predetermined distance from the edge of the cell, the predetermined distance being e.g. 20% of the diameter of the cell) may be determined to be UEs to undertake group handover. In this example, the UEs 500A and 500B would be expected to meet such criteria (for both the relay node 503 and target serving node 501B coverage areas) as they travel on the bus 504 with the relay node 503 from the cell of node 501A to the cell of node 501B. On the other hand, the UE 500C (not on the bus) will quickly fall out of the cell of relay node 503 and will not enter the cell of target serving node 501B. It can therefore be determined that UEs 500A and 500B should undertake group handover with the relay node 503 but not UE 500C. The location of each UE with respect to geographic regions within a cell of a node may be determined based on, for example, GNSS coordinates of the UE and node and a known size of the cell. Geographic region(s) within a cell may also be identified by respective zone ID(s), where each zone ID is identified as e.g. vertices and edges over a length and width of the cell (as, for example, in 3GPP Vehicle-to-Everything (V2X)). It may also be estimated based on, for example, the strength and/or quality of a reference signal transmitted by the node (e.g. reference signal received quality (RSRQ) or reference signal received power (RSRP)) or pathloss.

In another variation of FIG. 6, it is a speed of each UE relative to the relay node 503 which is determined. The characteristic is therefore that each UE which is to undertake group handover with the relay node 503 is travelling below a threshold speed with respect to the relay node 503. The threshold speed may be set at a speed which is faster than human users are likely to move within the bus 504 when inside it but slower than the average speed of the bus. For example, the threshold speed may be set at 5 miles per hour. This will mean that the UEs 500A and 500B within the bus 504 will undertake group handover with the relay node 503 whereas the UE 500C outside the bus will not undertake group handover.

The relay node 503 and/or each UE 500A-C may determine the speed of each UE with respect to the relay node based by measuring the Doppler shift of radio signals transmitted between each UE and the relay node (where a predetermined relationship between the amount of Doppler shift and speed is determined and stored in advance, with a greater amount of Doppler shift generally being associated with higher speed and vice versa) or based on a rate of change of location information (e.g. Global Navigation Satellite System (GNSS) coordinates) determined by each UE and the relay node, for example. The speed of a UE may be determined from the Doppler shift via the equation: Doppler shift=fc*v/c, where fc is the carrier frequency, v is the UE speed (m/s), c is the speed of light (3*10\hat{ }8 m/s).

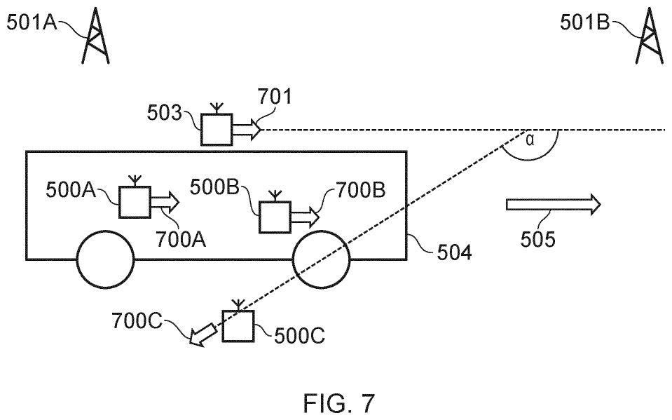

In the example of FIG. 7, the characteristic is that a direction of travel of each UE which is to undertake group handover with the relay node 503 and a direction of travel of the relay node are separated by less than a threshold angle. The relay node 503 and/or each UE 500A-C may determine its direction of travel based on an internal motion sensor (e.g. an accelerometer—not shown) or based on a direction of change of location information (e.g. Global Navigation Satellite System (GNSS) coordinates) determined by each UE and the relay node, for example. The method of detection of travel direction may depend on the UE function(s)/sensor(s). For example, a smart phone may have inertial sensor(s) (e.g. accelerometer, gyroscope and/or compass). These sensors indicate the direction of travel and current speed (calculated e.g. based on acceleration*time). A UE may need to activate the sensors in advance for the measurement because these sensors are usually inactive for power saving when an application which uses them is not running. A base station or location server may provide assistance information to the UE for guidance of when to undertake measurement (and therefore activate the sensor(s)), such as the criteria of activation, when to activate, where, which sensor, when to deactivate and so on.

Here, the direction of travel 700A and 700B of the UEs 500A and 500B is substantially aligned with the direction of travel 701 of the relay node 503 (the relay node 503 and both UEs 500A and 500B being located on the bus 504 which is also travelling in this direction, as indicated by arrow 505). The angle between the direction of travel of the relay node 503 and each UE 500A and 500B is therefore substantially zero. On the other hand, the direction of travel 700C of the UE 500C is at an obtuse angle α with respect to the direction of travel 701 of the relay node 503. This indicates that the UE 500C and relay node 503 are travelling in substantially different directions. UEs 500A and 500B thus undertake group handover with the relay node 503 from node 501A to node 501B. On the other hand, UE 500C undertakes a separate handover operation from relay node 503 to another network node. The threshold angle may be set at any suitable angle to enable UEs travelling with the relay node 503 to be distinguished from UEs not travelling with the relay node 503. In an example, the threshold angle may be set at between 30° and 90°. For a faster-moving bus (e.g. intercity express services), this threshold angle may be even smaller (e.g. 10° or less) since higher bus speeds mean any movement UEs by passengers inside the bus will have a negligible effect on the overall direction of travel of those UEs.

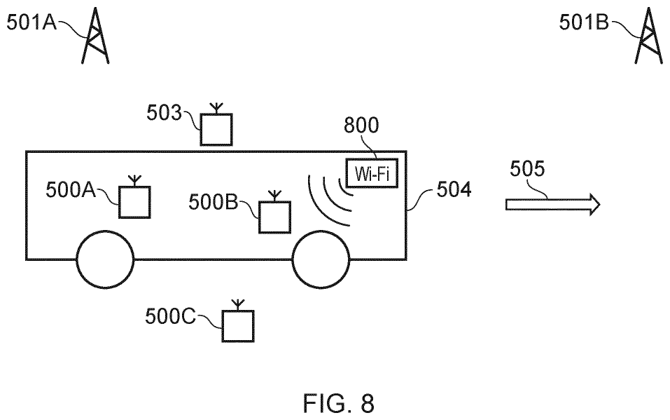

In the example of FIG. 8, the characteristic is that a secondary wireless signal (that is, a wireless signal transmitted by a transmitter other than the relay node 503) is detectable by the UE. The secondary wireless signal may be a short range radio signal associated with the bus 504, for example a Wi-Fi signal for passenger use. A Wi-Fi signal (transmitted from Wi-Fi transceiver 800) is the example given in FIG. 8 (although it could be another type of short range wireless signal such as a Bluetooth signal). Due to the short range of the secondary wireless signal, only UEs located on the bus (i.e. UEs 500A and 500B) are able to detect the secondary wireless signal (e.g. to receive the secondary wireless signal with a sufficient signal strength and/or quality to receive data via the secondary wireless signal). The secondary wireless signal comprises information (e.g. a unique identifier) associated with the relay node 503 so that the UEs 500A and 500B know to perform group handover with the relay node 503 when the secondary wireless signal is detectable. On the other hand, since the UE 500C is outside the bus 504 and cannot detect the secondary wireless signal, it knows it should not perform group handover with the relay node 503 but, rather, should seek an alternative network node once group handover of the relay node 503 and UEs 500A and 500B is initiated.

In an example, UEs may report a wireless local area network (WLAN, e.g. Wi-Fi) measurement result to a base station to allow the base station to know a group of UEs. For example, the measurement report of a Wi-Fi signal for WLAN interworking in LTE REL-13 can be reused for grouping. The measurement report includes the WLAN ID ((Service Set Identifier, SSID), Basic Service Set Identifier, BSSID)) and signal strength (RSSI WLAN). The network may provide the measurement configuration to each UE.

MeasResults Information Element for WLAN (REL-13 LTE from [3])

MeasResultWLAN-r13 ::= SEQUENCE {

| | |
|---|---|
| wlan-Identifiers-r13 | WLAN-Identifiers-r12, |
| carrierInfoWLAN-r13 | WLAN-CarrierInfo-r13 |

OPTIONAL,

| | |
|---|---|
| bandWLAN-r13 | WLAN-BandIndicator- |

| | |
|---|---|
| r13 | OPTIONAL, |

| | |
|---|---|
| rssiWLAN-r13 | WLAN-RSSI-Range-r13, |
| availableAdmissionCapacityWLAN-r13 | INTEGER (0..31250) |

OPTIONAL,

| | |
|---|---|
| backhaulDL-BandwidthWLAN-r13 | WLAN-backhaulRate-r12 |

OPTIONAL,

| | |
|---|---|
| backhaulUL-BandwidthWLAN-r13 | WLAN-backhaulRate-r12 |

OPTIONAL,

| | |
|---|---|
| channelUtilizationWLAN-r13 | INTEGER (0..255) |

OPTIONAL,

| | |
|---|---|
| stationCountWLAN-r13 | INTEGER (0..65535) |

OPTIONAL,

| | |
|---|---|
| connectedWLAN-r13 | ENUMERATED {true} |

OPTIONAL,

...
}

In another example, a UE may reuse a WLAN position method. In this case, the UE has assistance information from a network location server for WLAN positioning. The UE detects the WLAN (e.g. Wi-Fi) signal and determines e.g. the RSSI and/or round trip time between the UE and WLAN access point). The UE can then calculate the position with respect to/distance between it and the WLAN access point based on this information. Alternatively, the location server may receive the measurement result and calculate the position/distance information (instead of the UE).

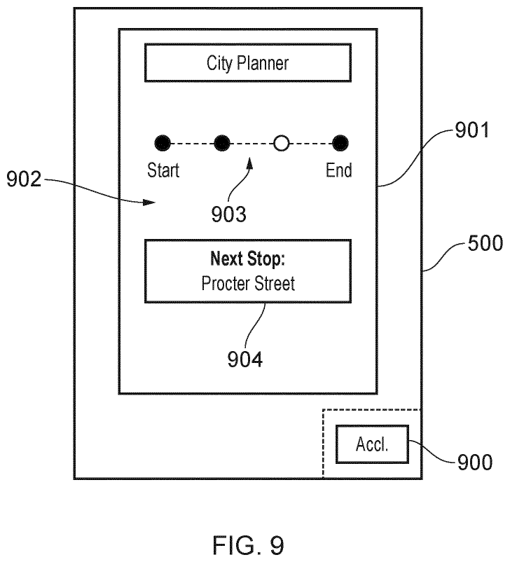

In the example of FIG. 9, the characteristic is that a predetermined context of the UE is determined from application data of the terminal device. The predetermined context is information about the UE which indicates group handover with the relay node 503 is appropriate for the UE. For example, the information is determined from application data generated by one or more software applications running on the UE.

In one example, the application data is generated by a software application monitoring output of an accelerometer 900 comprised within the UE (and controlled by the controlling processor of the UE). The output of the accelerometer over a given time period will have different characteristics depending on the type of movement of the UE. For example, the accelerometer output associated with a user walking will be different to that associated with a user travelling in a vehicle. The software application therefore monitors the accelerometer output and classifies the output (e.g. using a trained machine learning model executed by the processing circuitry of the UE) as either “walking” or “in a vehicle”. The UE thus only undertakes group handover with the relay node 503 (which, for example, transmits an identifier indicating it is a vehicle-mounted network node) when the accelerometer output indicates the user is “in a vehicle” (as would be the case for UEs 500A and 500B, for example). Otherwise, the user is determined to be “walking” and does not undertake group handover (as would be the case for UE 500C, for example).

In another example, the application data is generated from a navigation software application. The application data indicates travel plans of the user of the UE which can thus be used to decide on whether or not group handover with the relay node 503 is appropriate. A graphical user interface (GUI) 902 of the software application is displayed on an electronic display 901 of the UE 500 (the electronic display being controlled by the controlling processor of the UE). In this example, the software application is a “City Planner” software application which allows the UE user to see real time information about journeys they take. In this example, the user is on a bus and is presented with a timeline graphic 903 indicating the bus stops on the route and a “Next Stop” graphic 904 indicating the name of the next bus stop. The application data includes, for example, the name and/or location of the next bus stop and this can be cross-referenced with bus stops on the route of bus 504. If the next bus stop is on the route of bus 504, it is determined that the user is on the bus 504 and therefore group handover with the relay node 503 is appropriate. On the other than, if the user is not on bus 504 (e.g. they are on a different, older bus which does not have a relay node mounted on it but is passing by bus 504, thereby allowing the user's UE to temporarily be served by relay node 503), group handover is determined not to be appropriate.

It will be appreciated that there are many different ways application data generated by a UE could be used to predict user behaviour (and therefore future locations of the UE) so as to determine the applicability of group handover for that UE. FIG. 9 represents an example of these.

Thus, for each of these examples, the network efficiency of group handover is therefore retained for the UEs 500A and 500B. At the same time, group handover is not inappropriately applied to UE 500C and UE 500C is able to undertake a separate handover operation to a different suitable serving node. Network reliability is therefore improved.

Some or all of the above example characteristics may be combined such that all of those characteristics need to be satisfied in order for group handover to occur. For example, it may be that a UE must be both (a) within a predetermined distance of the relay node and (b) travelling below a certain speed with respect to the relay node in order for group handover with the relay node 503 to occur. This may help improve the reliability of the system since, for example, it will discount UEs in other vehicles passing the bus 504. In another example, it may be that a UE must both (a) detect a secondary wireless signal (e.g. Wi-Fi) from the bus and (b) generate relevant application data in order for group handover with the relay node 503 to occur. This may help improve the reliability of the system since, for example, it will discount UEs whose users are using a navigation software application whilst waiting at a bus stop for a different bus to bus 504.

There are a number of options regarding the network signalling to implement group handover according to the present disclosure.

In one example, the relay node 503 broadcasts (e.g. in the system information) or otherwise signals (e.g. through dedicated signalling) the group handover characteristic(s) to all UEs 500A-C and any further information (e.g. relay node position, relay node moving direction) required for each UE to determine whether or not it meets the characteristic(s) (and therefore whether or not it should undertake group handover with the relay node 503).

In another example, the relay node 503 determines whether each UE meets the group handover characteristic(s) (e.g. based on each UE's position, UE's moving direction) and sends group handover signalling only to those UEs which meet the handover characteristic(s). In a further example, the relay node 503 may send legacy handover signalling to the remaining UEs which do not meet the handover characteristic(s) and which therefore need to complete a separate handover (“legacy” handover) to a different target node.

In another example, the relay node 503 sends group handover signalling with the group handover characteristic(s). This may be referred to as conditional group handover signalling. Only UEs which meet the group handover characteristic(s) will then implement group handover in response to the group handover signalling. The remaining UEs perform which do not meet the handover characteristic(s) may then perform a legacy handover to a different target node (e.g. in response to legacy handover signalling transmitted by the relay node 503 with or after the conditional group handover signalling).

In another example, if the probability of any UE being servable by the target serving node the relay node 503 is moving to is below a predetermined threshold (e.g. less than 10%, based on e.g. the UE being located at the edge of the relay node's cell when the relay node is moving away from the UE), the relay node 503 may transmit a radio resource control (RRC) release message to the UE. This frees the UE to then connect to a different network node in a conventional manner. In a further example, the RRC release message is conditional (so release is only implemented by the UE if the UE itself determines certain criteria are met, e.g. the probably of the UE being servable by the target serving node of the relay node 503 is below the predetermined threshold). In a further example, the RRC release message may also indicate a new target node (e.g. a local fixed gNB) for the released UE to connect to.

In other example, each UE is configured to send a measurement report to the relay node 503 when the group handover characteristic(s) are met (or, alternatively, not met). The relay node 503 then knows which UEs meet the group handover characteristic(s) based on which UE transmit (or do not transmit) a measurement report. In a further example, in the case where a UE transmits a measurement report when it does not meet the group handover characteristic(s), the relay node 503 may transmit a legacy handover configuration to the UE in response to receiving the report. In an example, each UE determines if it has the one or more predetermined characteristics based on pre-stored information indicating the one or more predetermined characteristics and/or received network configuration information indicating the one or more predetermined characteristics.

In an example, a UE may be handed over to a relay node from infrastructure equipment (e.g. a macro cell) of the network based on one or more further predetermined characteristics (which may include one or more of the group handover characteristic(s) or may include different characteristic(s)). For example, a further UE (not shown in the figures) may initially be served by node 501B but, as the bus 504 approaches, the UE may determine, based on the relay device 503 becoming closer in distance to it than node 501B, that it would be better served by the relay device 503. Here, the relay device 503 becoming closer in distance to the UE than node 501B is an example of a further predetermined characteristic. In an example, the UE sends a measurement report to the node 501B when it determines it has the one or more further predetermined characteristics. A handover procedure from the node 501B to the relay device 503 is then initiated in response to this measurement report.

For group handover to successfully occur, radio resources at the target serving node of the relay node (e.g. node 501B) must be reserved. It is desirable to keep the balance between handover performance (reserving more resources) and efficient resource utilization (reserving fewer resources). In an example, the relay node 503 estimates how many UEs are going to perform group handover according to the number of UEs determined to meet the group handover characteristic(s). The relay node 503 then signals this information to the target serving node. This allows the target serving node to reserve an appropriate number of resources (rather than e.g. reserving sufficient resources for all UEs to implement group handover with the relay node 503 when some of the UEs will not be included in the group handover), thereby allowing network resources to be used more efficiently.

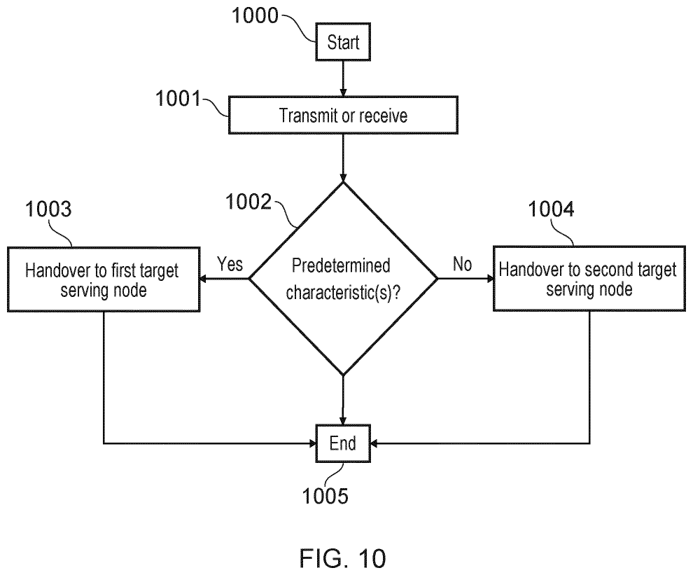

FIG. 10 shows an example method of the present disclosure. The method may be implemented by one or more entities of a telecommunications network. For example, it may be implemented by infrastructure equipment (e.g. node 501A or 501B), a relay device (e.g. relay node 503) and/or a terminal device (e.g. UE 500C).

The method starts at step 1000.

At step 1001, a terminal device (e.g. UE 500C) transmits uplink signals to or receives downlink signals from a serving node (e.g. node 501A) via a relay device (e.g. relay node 503).

At step 1002, it is determined if the terminal device has one or more predetermined characteristics indicating the terminal device should be handed over from a source serving node (e.g. node 501A) to a first target serving node (e.g. node 501B) if the relay device is handed over from the source serving node to the first target serving node.

If the terminal device has the one or more predetermined characteristics, the method proceeds to step 1003 in which the terminal device transmits and/or receives one or more handover signals for handover of the terminal device from the source serving node to the first target serving node if the relay device is handed over from the source serving node to the first target serving node.

On the other hand, if the terminal device does not have the one or more predetermined characteristics, the method proceeds to step 1004 in which the terminal device transmits and/or receives one or more handover signals for handover of the terminal device from the source serving node to a second, different, target serving node (e.g. a node other than node 501B) if the relay device is handed over from the source serving node to the first target serving node.

The method ends at step 1005.

Some embodiments of the present disclosure are defined by the following numbered clauses:
1. A wireless telecommunications method comprising:
   determining if a terminal device configured to transmit uplink signals to or receive downlink signals from a serving node via a relay device has one or more predetermined characteristics indicating the terminal device should be handed over from a source serving node to a first target serving node if the relay device is handed over from the source serving node to the first target serving node;
   if the terminal device has the one or more predetermined characteristics, controlling the terminal device to be handed over from the source serving node to the first target serving node if the relay device is handed over from the source serving node to the first target serving node; and
   if the terminal device does not have the one or more predetermined characteristics, controlling the terminal device to be handed over from the source serving node to a second, different, target serving node if the relay device is handed over from the source serving node to the first target serving node.
2. A wireless telecommunications method according to clause 1 wherein the one or more predetermined characteristics comprise that the terminal device is located below a threshold distance from the relay device.
3. A wireless telecommunications method according to any preceding clause wherein the one or more predetermined characteristics comprise that the terminal device is located below a threshold distance from the first target serving node.
4. A wireless telecommunications method according to any preceding clause wherein the one or more predetermined characteristics comprise that the terminal device is travelling below a threshold speed with respect to the relay device.
5. A wireless telecommunications method according to clause 4 wherein the speed of the terminal device with respect to the relay device is measured based on a Doppler shift of a wireless signal transmitted between the terminal device and relay device.
6. A wireless telecommunications method according to any preceding clause wherein the one or more predetermined characteristics comprise that a direction of travel of the terminal device and a direction of travel of the relay device are separated by less than a threshold angle.
7. A wireless telecommunications method according to any preceding clause wherein the one or more predetermined characteristics comprise that the terminal device is located within a predetermined geographic area within a cell of the first target serving node.
8. A wireless telecommunications method according to any preceding clause wherein the one or more predetermined characteristics comprise that a secondary wireless signal associated with the relay device is detectable by the terminal device.
9. A wireless telecommunications method according to clause 8 wherein the secondary wireless signal is a Wi-Fi signal.
10. A wireless telecommunications method according to clause 9 wherein the relay device is vehicle-mounted relay device and the Wi-Fi signal is a Wi-Fi signal transmitted from the vehicle.
11. A wireless telecommunications method according to any preceding clause wherein the one or more predetermined characteristics comprise that a predetermined context of the terminal device is determined from application data of the terminal device.
12. A wireless telecommunications method according to any preceding clause wherein the relay device is one of a relay terminal device, an Integrated Access and Backhaul, IAB, node and a Non-Terrestrial Network, NTN, node.
13. A wireless telecommunications method according to any preceding clause, wherein information indicating the one or more predetermined characteristics is transmitted to the terminal device via broadcast or dedicated signalling.
14. A wireless telecommunications method according to any preceding clause, wherein determining if the terminal device has the one or more predetermined characteristics is based on the transmission of a measurement report by the terminal device.
15. A wireless telecommunications method according to clause 14, wherein the terminal device transmits the measurement report either (i) if it has the one or more predetermined characteristics or (ii) if it does not have the one or more predetermined characteristics.
16. A wireless telecommunications method according to clause 15, wherein the terminal device determines if it has the one or more predetermined characteristics based on pre-stored information indicating the one or more predetermined characteristics and/or received network configuration information indicating the one or more predetermined characteristics.
17. A wireless telecommunications method according to any preceding clause, wherein, if the terminal device does not have the one or more predetermined characteristics, a radio resource control, RRC, release message is transmitted to the terminal device if the relay device is handed over from the source serving node to the first target serving node.
18. A wireless telecommunications method according to any preceding clause, wherein, if the terminal device has the one or more predetermined characteristics, the source serving node notifies the first target serving node to reserve radio resources for serving the terminal device.
19. A wireless telecommunications method according to any preceding clause, wherein the method comprises, prior to the terminal device transmitting uplink signals to or receiving downlink signals from the serving node via the relay device:
   controlling the terminal device to transmit uplink signals directly to or receive downlink signals directly from network infrastructure equipment;
   determining, based on the transmission of a measurement report by the terminal device to the network infrastructure equipment, whether the terminal device has one or more further predetermined characteristics; and
   if the terminal device has the one or more further predetermined characteristics, controlling the terminal device to be handed over from the infrastructure equipment to the relay device.
20. A terminal device for use in a wireless telecommunications network, the terminal device comprising:
   transceiver circuitry configured to transmit uplink signals to or receive downlink signals from a serving node via a relay device; and
   control circuitry configured to:
   determine if the terminal device has one or more predetermined characteristics indicating the terminal device should be handed over from a source serving node to a first target serving node if the relay device is handed over from the source serving node to the first target serving node;
   if the terminal device has the one or more predetermined characteristics, control the transceiver circuitry to transmit and/or receive one or more handover signals for handover of the terminal device from the source serving node to the first target serving node if the relay device is handed over from the source serving node to the first target serving node; and
   if the terminal device does not have the one or more predetermined characteristics, control the transceiver circuitry to transmit and/or receive one or more handover signals for handover of the terminal device from the source serving node to a second, different, target serving node if the relay device is handed over from the source serving node to the first target serving node.
21. A terminal device according to clause 20 wherein the one or more predetermined characteristics comprise that the terminal device is located below a threshold distance from the relay device.
22. A terminal device according to any one of clauses 20 to 21 wherein the one or more predetermined characteristics comprise that the terminal device is located below a threshold distance from the first target serving node.
23. A terminal device according to any one of clauses 20 to 22 wherein the one or more predetermined characteristics comprise that the terminal device is travelling below a threshold speed with respect to the relay device.
24. A terminal device according to clause 23 wherein the speed of the terminal device with respect to the relay device is measured based on a Doppler shift of a wireless signal transmitted between the terminal device and relay device.
25. A terminal device according to any one of clauses 20 to 24 wherein the one or more predetermined characteristics comprise that a direction of travel of the terminal device and a direction of travel of the relay device are separated by less than a threshold angle.
26. A terminal device according to any one of clauses 20 to 25 wherein the one or more predetermined characteristics comprise that the terminal device is located within a predetermined geographic area within a cell of the first target serving node.
27. A terminal device according to any one of clauses 20 to 26 wherein the one or more predetermined characteristics comprise that a secondary wireless signal associated with the relay device is detectable by the terminal device.
28. A terminal device according to clause 27 wherein the secondary wireless signal is a Wi-Fi signal.
29. A terminal device according to clause 28 wherein the relay device is vehicle-mounted relay device and the Wi-Fi signal is a Wi-Fi signal transmitted from the vehicle.
30. A terminal device according to any one of clauses 20 to 29 wherein the one or more predetermined characteristics comprise that a predetermined context of the terminal device is determined from application data of the terminal device.
31 A terminal device according to any one of clauses 20 to 30 wherein the relay device is one of a relay terminal device, an Integrated Access and Backhaul, IAB, node and a Non-Terrestrial Network, NTN, node.
32. A terminal device according to any one of clauses 20 to 31, wherein information indicating the one or more predetermined characteristics is transmitted to the terminal device via broadcast or dedicated signalling.
33. A terminal device according to any one of clauses 20 to 32, wherein determining if the terminal device has the one or more predetermined characteristics is based on the transmission of a measurement report by the terminal device.
34. A terminal device according to clause 33, wherein the terminal device transmits the measurement report either (i) if it has the one or more predetermined characteristics or (ii) if it does not have the one or more predetermined characteristics.
35. A terminal device according to clause 34, wherein the terminal device determines if it has the one or more predetermined characteristics based on pre-stored information indicating the one or more predetermined characteristics and/or received network configuration information indicating the one or more predetermined characteristics.
36. A terminal device according to any one of clauses 20 to 35, wherein, if the terminal device does not have the one or more predetermined characteristics, a radio resource control, RRC, release message is transmitted to the terminal device if the relay device is handed over from the source serving node to the first target serving node.
37. A terminal device according to any one of clauses 20 to 36, wherein, if the terminal device has the one or more predetermined characteristics, the source serving node notifies the first target serving node to reserve radio resources for serving the terminal device.
38. A terminal device according to any one of clauses 20 to 37, wherein, prior to the transceiver circuitry transmitting uplink signals to or receiving downlink signals from the serving node via the relay device, the control circuitry is configured to:
   control the transceiver circuitry to transmit uplink signals directly to or receive downlink signals directly from network infrastructure equipment;
   control the transceiver circuitry to transmit a measurement report to the infrastructure equipment, the network infrastructure equipment being configured to determine, based on the measurement report, whether the terminal device has one or more further predetermined characteristics; and
   if the terminal device has the one or more further predetermined characteristics, control the terminal device to be handed over from the infrastructure equipment to the relay device.
39. A relay device for use in a wireless telecommunications network, the relay device comprising:
   transceiver circuitry configured to relay uplink signals transmitted by a terminal device to a serving node or relay downlink signals transmitted by the serving node to the terminal device; and
   control circuitry configured to:
   determine if the terminal device has one or more predetermined characteristics indicating the terminal device should be handed over from a source serving node to a first target serving node if the relay device is handed over from the source serving node to the first target serving node;
   if the terminal device has the one or more predetermined characteristics, control the transceiver circuitry to transmit and/or receive one or more handover signals for handover of the terminal device from the source serving node to the first target serving node if the relay device is handed over from the source serving node to the first target serving node; and
   if the terminal device does not have the one or more predetermined characteristics, control the transceiver circuitry to transmit and/or receive one or more handover signals for handover of the terminal device from the source serving node to a second, different, target serving node if the relay device is handed over from the source serving node to the first target serving node.
40. A relay device according to clause 39 wherein the one or more predetermined characteristics comprise that the terminal device is located below a threshold distance from the relay device.
41. A relay device according to any one of clauses 39 to 40 wherein the one or more predetermined characteristics comprise that the terminal device is located below a threshold distance from the first target serving node.
42. A relay device according to any one of clauses 39 to 41 wherein the one or more predetermined characteristics comprise that the terminal device is travelling below a threshold speed with respect to the relay device.
43. A relay device according to clause 42 wherein the speed of the terminal device with respect to the relay device is measured based on a Doppler shift of a wireless signal transmitted between the terminal device and relay device.
44. A relay device according to any one of clauses 39 to 43 wherein the one or more predetermined characteristics comprise that a direction of travel of the terminal device and a direction of travel of the relay device are separated by less than a threshold angle.
45. A relay device according to any one of clauses 39 to 44 wherein the one or more predetermined characteristics comprise that the terminal device is located within a predetermined geographic area within a cell of the first target serving node.
46. A relay device according to any one of clauses 39 to 45 wherein the one or more predetermined characteristics comprise that a secondary wireless signal associated with the relay device is detectable by the terminal device.
47. A relay device according to clause 46 wherein the secondary wireless signal is a Wi-Fi signal.
48. A relay device according to clause 47 wherein the relay device is vehicle-mounted relay device and the Wi-Fi signal is a Wi-Fi signal transmitted from the vehicle.
49. A relay device according to any one of clauses 39 to 48 wherein the one or more predetermined characteristics comprise that a predetermined context of the terminal device is determined from application data of the terminal device.
50. A relay device according to any one of clauses 39 to 49 wherein the relay device is one of a relay terminal device, an Integrated Access and Backhaul, IAB, node and a Non-Terrestrial Network, NTN, node.
51. A relay device according to any one of clauses 39 to 50, wherein information indicating the one or more predetermined characteristics is transmitted to the terminal device via broadcast or dedicated signalling.
52. A relay device according to any one of clauses 39 to 51, wherein determining if the terminal device has the one or more predetermined characteristics is based on the transmission of a measurement report by the terminal device.
53. A relay device according to clause 52, wherein the terminal device transmits the measurement report either (i) if it has the one or more predetermined characteristics or (ii) if it does not have the one or more predetermined characteristics.
54 A relay device according to clause 53 wherein the terminal device determines if it has the one or more predetermined characteristics based on pre-stored information indicating the one or more predetermined characteristics and/or received network configuration information indicating the one or more predetermined characteristics.
55. A relay device according to any one of clauses 39 to 54, wherein, if the terminal device does not have the one or more predetermined characteristics, a radio resource control, RRC, release message is transmitted to the terminal device if the relay device is handed over from the source serving node to the first target serving node.
56. A relay device according to any one of clauses 39 to 55, wherein, if the terminal device has the one or more predetermined characteristics, the source serving node notifies the first target serving node to reserve radio resources for serving the terminal device.
57. A relay device according to any one of clauses 39 to 56, wherein, prior to the terminal device transmitting uplink signals to or receiving downlink signals from the serving node via the relay device:
   the terminal device transmits uplink signals directly to or receives downlink signals directly from network infrastructure equipment;
   it is determined, based on the transmission of a measurement report by the terminal device to the network infrastructure equipment, whether the terminal device has one or more further predetermined characteristics; and
   if the terminal device has the one or more further predetermined characteristics, the terminal device is handed over from the infrastructure equipment to the relay device.
58. Infrastructure equipment for use in a wireless telecommunications network, the infrastructure equipment comprising:
   transceiver circuitry configured to transmit downlink signals to or receive uplink signals from a terminal device via a relay device; and
   control circuitry configured to:
   determine if the terminal device has one or more predetermined characteristics indicating the terminal device should be handed over from a source serving node to a first target serving node if the relay device is handed over from the source serving node to the first target serving node;
   if the terminal device has the one or more predetermined characteristics, control the transceiver circuitry to transmit and/or receive one or more handover signals for handover of the terminal device from the source serving node to the first target serving node if the relay device is handed over from the source serving node to the first target serving node; and
   if the terminal device does not have the one or more predetermined characteristics, control the transceiver circuitry to transmit and/or receive one or more handover signals for handover of the terminal device from the source serving node to a second, different, target serving node if the relay device is handed over from the source serving node to the first target serving node.
59. Infrastructure equipment according to clause 58 wherein the one or more predetermined characteristics comprise that the terminal device is located below a threshold distance from the relay device.
60. Infrastructure equipment according to any one of clauses 58 to 59 wherein the one or more predetermined characteristics comprise that the terminal device is located below a threshold distance from the first target serving node.
61. Infrastructure equipment according to any one of clauses 58 to 60 wherein the one or more predetermined characteristics comprise that the terminal device is travelling below a threshold speed with respect to the relay device.
62. Infrastructure equipment according to clause 61 wherein the speed of the terminal device with respect to the relay device is measured based on a Doppler shift of a wireless signal transmitted between the terminal device and relay device.
63. Infrastructure equipment according to any one of clauses 58 to 62 wherein the one or more predetermined characteristics comprise that a direction of travel of the terminal device and a direction of travel of the relay device are separated by less than a threshold angle.
64. Infrastructure equipment according to any one of clauses 58 to 63 wherein the one or more predetermined characteristics comprise that the terminal device is located within a predetermined geographic area within a cell of the first target serving node.
65 Infrastructure equipment according to any one of clauses 58 to 65 wherein the one or more predetermined characteristics comprise that a secondary wireless signal associated with the relay device is detectable by the terminal device.
66. Infrastructure equipment according to clause 65 wherein the secondary wireless signal is a Wi-Fi signal.
67. Infrastructure equipment according to clause 66 wherein the relay device is vehicle-mounted relay device and the Wi-Fi signal is a Wi-Fi signal transmitted from the vehicle.
68. Infrastructure equipment according to any one of clauses 58 to 67 wherein the one or more predetermined characteristics comprise that a predetermined context of the terminal device is determined from application data of the terminal device.
69. Infrastructure equipment according to any one of clauses 58 to 68 wherein the relay device is one of a relay terminal device, an Integrated Access and Backhaul, IAB, node and a Non-Terrestrial Network, NTN, node.
70. Infrastructure equipment according to any one of clauses 58 to 69, wherein information indicating the one or more predetermined characteristics is transmitted to the terminal device via broadcast or dedicated signalling.
71. Infrastructure equipment according to any one of clauses 58 to 70, wherein determining if the terminal device has the one or more predetermined characteristics is based on the transmission of a measurement report by the terminal device.
72. Infrastructure equipment according to clause 71, wherein the terminal device transmits the measurement report either (i) if it has the one or more predetermined characteristics or (ii) if it does not have the one or more predetermined characteristics.
73 Infrastructure equipment according to clause 72 wherein the terminal device determines if it has the one or more predetermined characteristics based on pre-stored information indicating the one or more predetermined characteristics and/or received network configuration information indicating the one or more predetermined characteristics.
74. Infrastructure equipment according to any one of clauses 58 to 73, wherein, if the terminal device does not have the one or more predetermined characteristics, a radio resource control, RRC, release message is transmitted to the terminal device if the relay device is handed over from the source serving node to the first target serving node.
75. Infrastructure equipment according to any one of clauses 58 to 74, wherein, if the terminal device has the one or more predetermined characteristics, the source serving node notifies the first target serving node to reserve radio resources for serving the terminal device.
76. A relay device according to any one of clauses 58 to 75, wherein, prior to the terminal device transmitting uplink signals to or receiving downlink signals from the serving node via the relay device, the control circuitry is configured to:
   control the transceiver circuitry to receive uplink signals directly from or transmit downlink signals directly to the terminal device;
   determined, based on the transmission of a measurement report by the terminal device to the infrastructure equipment, whether the terminal device has one or more further predetermined characteristics; and
   if the terminal device has the one or more further predetermined characteristics, control the terminal device to be handed over from the infrastructure equipment to the relay device.
77. A wireless telecommunications system comprising a terminal device, a relay device and a plurality of serving nodes for serving the terminal device and/or relay device, the terminal device being configured to transmit uplink signals to or receive downlink signals from a source serving node of the plurality of serving nodes via the relay device, wherein the wireless telecommunications system comprises control circuitry configured to:
   determine if the terminal device has one or more predetermined characteristics indicating the terminal device should be handed over from the source serving node to a first target serving node of the plurality of serving nodes if the relay device is handed over from the source serving node to the first target serving node;
   if the terminal device has the one or more predetermined characteristics, controlling the terminal device to be handed over from the source serving node to the first target serving node if the relay device is handed over from the source serving node to the first target serving node; and
   if the terminal device does not have the one or more predetermined characteristics, controlling the terminal device to be handed over from the source serving node to a second, different, target serving node of the plurality of serving nodes if the relay device is handed over from the source serving node to the first target serving node.
78. A method of operating a terminal device of a wireless telecommunications network, the method comprising controlling the terminal device to:
   transmit uplink signals to or receive downlink signals from a serving node via a relay device; and
   determine if the terminal device has one or more predetermined characteristics indicating the terminal device should be handed over from a source serving node to a first target serving node if the relay device is handed over from the source serving node to the first target serving node;
   if the terminal device has the one or more predetermined characteristics, control the terminal device to transmit and/or receive one or more handover signals for handover of the terminal device from the source serving node to the first target serving node if the relay device is handed over from the source serving node to the first target serving node; and
   if the terminal device does not have the one or more predetermined characteristics, control the terminal device to transmit and/or receive one or more handover signals for handover of the terminal device from the source serving node to a second, different, target serving node if the relay device is handed over from the source serving node to the first target serving node.
79. A method of operating a relay device of a wireless telecommunications network, the method comprising controlling the terminal device to:
   relay uplink signals transmitted by a terminal device to a serving node or relay downlink signals transmitted by the serving node to the terminal device; and
   determine if the terminal device has one or more predetermined characteristics indicating the terminal device should be handed over from a source serving node to a first target serving node if the relay device is handed over from the source serving node to the first target serving node;
   if the terminal device has the one or more predetermined characteristics, control the relay device to transmit and/or receive one or more handover signals for handover of the terminal device from the source serving node to the first target serving node if the relay device is handed over from the source serving node to the first target serving node; and
   if the terminal device does not have the one or more predetermined characteristics, control the relay device to transmit and/or receive one or more handover signals for handover of the terminal device from the source serving node to a second, different, target serving node if the relay device is handed over from the source serving node to the first target serving node.
80. A method of operating infrastructure equipment of a wireless telecommunications network, the method comprising controlling the infrastructure equipment to:
   transmit downlink signals to or receive uplink signals from a terminal device via a relay device; and
   determine if the terminal device has one or more predetermined characteristics indicating the terminal device should be handed over from a source serving node to a first target serving node if the relay device is handed over from the source serving node to the first target serving node;
   if the terminal device has the one or more predetermined characteristics, control the infrastructure equipment to transmit and/or receive one or more handover signals for handover of the terminal device from the source serving node to the first target serving node if the relay device is handed over from the source serving node to the first target serving node; and
   if the terminal device does not have the one or more predetermined characteristics, control the infrastructure equipment to transmit and/or receive one or more handover signals for handover of the terminal device from the source serving node to a second, different, target serving node if the relay device is handed over from the source serving node to the first target serving node.
81. A program for controlling a computer to perform a method according to any one of clauses 1 to 19 or 78 to 80.
82. A storage medium storing a program according to clause 81.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

### REFERENCES

[1] Holma H. and Toskala A, “LTE for UMTS OFDMA and SC-FDMA based radio access”, John Wiley and Sons, 2009.
[2] 3GPP TR 36.746 V1.1.0
[3] 3GPP TS 36.331 V13.12.0

1. A wireless telecommunications method comprising:
determining if a terminal device configured to transmit uplink signals to or receive downlink signals from a serving node via a relay device has one or more predetermined characteristics indicating the terminal device should be handed over from a source serving node to a first target serving node if the relay device is handed over from the source serving node to the first target serving node;
if the terminal device has the one or more predetermined characteristics, controlling the terminal device to be handed over from the source serving node to the first target serving node if the relay device is handed over from the source serving node to the first target serving node; and
if the terminal device does not have the one or more predetermined characteristics, controlling the terminal device to be handed over from the source serving node to a second, different, target serving node if the relay device is handed over from the source serving node to the first target serving node.

2. A wireless telecommunications method according to claim 1 wherein the one or more predetermined characteristics comprise that the terminal device is located below a threshold distance from the relay device.

3. A wireless telecommunications method according to claim 1 wherein the one or more predetermined characteristics comprise that the terminal device is located below a threshold distance from the first target serving node.

4. A wireless telecommunications method according to claim 1 wherein the one or more predetermined characteristics comprise that the terminal device is travelling below a threshold speed with respect to the relay device.

5. A wireless telecommunications method according to claim 4 wherein the speed of the terminal device with respect to the relay device is measured based on a Doppler shift of a wireless signal transmitted between the terminal device and relay device.

6. A wireless telecommunications method according to claim 1 wherein the one or more predetermined characteristics comprise that a direction of travel of the terminal device and a direction of travel of the relay device are separated by less than a threshold angle.

7. A wireless telecommunications method according to claim 1 wherein the one or more predetermined characteristics comprise that the terminal device is located within a predetermined geographic area within a cell of the first target serving node.

8. A wireless telecommunications method according to claim 1 wherein the one or more predetermined characteristics comprise that a secondary wireless signal associated with the relay device is detectable by the terminal device.

9. A wireless telecommunications method according to claim 8 wherein the secondary wireless signal is a Wi-Fi signal.

10. A wireless telecommunications method according to claim 9 wherein the relay device is vehicle-mounted relay device and the Wi-Fi signal is a Wi-Fi signal transmitted from the vehicle.

11. A wireless telecommunications method according to claim 1 wherein the one or more predetermined characteristics comprise that a predetermined context of the terminal device is determined from application data of the terminal device.

12. A wireless telecommunications method according to any claim 1 wherein the relay device is one of a relay terminal device, an Integrated Access and Backhaul, IAB, node and a Non-Terrestrial Network, NTN, node.

13. A wireless telecommunications method according to claim 1, wherein information indicating the one or more predetermined characteristics is transmitted to the terminal device via broadcast or dedicated signalling.

14. A wireless telecommunications method according to claim 1, wherein determining if the terminal device has the one or more predetermined characteristics is based on the transmission of a measurement report by the terminal device.

15. A wireless telecommunications method according to claim 14, wherein the terminal device transmits the measurement report either (i) if it has the one or more predetermined characteristics or (ii) if it does not have the one or more predetermined characteristics.

16. A wireless telecommunications method according to claim 15, wherein the terminal device determines if it has the one or more predetermined characteristics based on pre-stored information indicating the one or more predetermined characteristics and/or received network configuration information indicating the one or more predetermined characteristics.

17. A wireless telecommunications method according to claim 1, wherein, if the terminal device does not have the one or more predetermined characteristics, a radio resource control, RRC, release message is transmitted to the terminal device if the relay device is handed over from the source serving node to the first target serving node.

18. A wireless telecommunications method according to claim 1, wherein, if the terminal device has the one or more predetermined characteristics, the source serving node notifies the first target serving node to reserve radio resources for serving the terminal device.

19. (canceled)

20. A terminal device for use in a wireless telecommunications network, the terminal device comprising:
transceiver circuitry configured to transmit uplink signals to or receive downlink signals from a serving node via a relay device; and
control circuitry configured to:
determine if the terminal device has one or more predetermined characteristics indicating the terminal device should be handed over from a source serving node to a first target serving node if the relay device is handed over from the source serving node to the first target serving node;
if the terminal device has the one or more predetermined characteristics, control the transceiver circuitry to transmit and/or receive one or more handover signals for handover of the terminal device from the source serving node to the first target serving node if the relay device is handed over from the source serving node to the first target serving node; and
if the terminal device does not have the one or more predetermined characteristics, control the transceiver circuitry to transmit and/or receive one or more handover signals for handover of the terminal device from the source serving node to a second, different, target serving node if the relay device is handed over from the source serving node to the first target serving node.

21.-38. (canceled)

39. A relay device for use in a wireless telecommunications network, the relay device comprising:
transceiver circuitry configured to relay uplink signals transmitted by a terminal device to a serving node or relay downlink signals transmitted by the serving node to the terminal device; and
control circuitry configured to:
determine if the terminal device has one or more predetermined characteristics indicating the terminal device should be handed over from a source serving node to a first target serving node if the relay device is handed over from the source serving node to the first target serving node;
if the terminal device has the one or more predetermined characteristics, control the transceiver circuitry to transmit and/or receive one or more handover signals for handover of the terminal device from the source serving node to the first target serving node if the relay device is handed over from the source serving node to the first target serving node; and
if the terminal device does not have the one or more predetermined characteristics, control the transceiver circuitry to transmit and/or receive one or more handover signals for handover of the terminal device from the source serving node to a second, different, target serving node if the relay device is handed over from the source serving node to the first target serving node.

40.-82. (canceled)
